(19) United States
(12) Patent Application Publication
(10) Pub. No.: US 2015/0294371 A1
(43) Pub. Date: Oct. 15, 2015

(54) METHOD AND SYSTEM FOR BIDDING OF ADVERTISEMENT SLOTS

(71) Applicant: KOMLI MEDIA INC., Redwood City, CA (US)

(72) Inventor: Vipul AGRAWAL, Bangalore (IN)

(73) Assignee: KOMLI MEDIA INC., Redwood City, CA (US)

(21) Appl. No.: 14/248,821

(22) Filed: Apr. 9, 2014

(51) Int. Cl. G06Q 30/02

(52) U.S. Cl. CPC G06Q 30/0275

(57) ABSTRACT

The present invention provides a method and system for determining revenue margin for a bidder for an advertisement slot. The method and system include receiving a candidate set of inputs associated with an advertisement impression and a specified advertisement campaign from an advertiser. Further, the method and system include computing a probable amount of money to be paid to a publisher of the advertising slot and calculating a probable amount of money to be received from the advertiser. In addition, the method and system include determining the revenue margin for the advertisement slot based on difference of the probable amount of money to be paid to the publisher and the probable amount of money to be received from an advertiser for the candidate set of inputs. The probable amount of money to be received from the advertiser is based on an analysis of historical data for the advertising slot.

### TECHNICAL FIELD

The present technology generally relates to methods and systems for trading online advertising space, and more particularly, relates to methods and systems for maximizing revenue margin for a bidder for the advertisement space.

### BACKGROUND

Nowadays, most of the online content providers allocate some portions of their web-pages for advertising revenues. In fact, some of the online content providers write content or useful articles only to generate revenue from the advertisements. The more the number of the visitors on their web-pages, the better are the chances of getting high income from the advertisements itself.

These allocated portions on the web-pages are sometimes referred to as impression opportunities or advertisement slots. Some of the advertisement slots are available for advertising products, services, or businesses related to the online publishers. For example, a person providing online content on fitness may like to advertise only sporty products such as shoes on his web-page rather than a sleep mattress. In another scenario, the publisher may not have the rights for the types of advertisements to be published on his web-page. In this case, the advertisement slots are available for advertising products, services, or businesses which may or may not be related to the online publishers.

These advertisement slots are available to advertisers for a price. These advertisement slots are sometimes made available directly to advertisers and/or through one or more advertising networks and advertising exchanges. These advertisement networks and/or advertisement exchanges operate as intermediaries. In some cases, these advertising exchanges provide a platform for buying and selling advertising impressions/advertisement slots by consolidating and managing advertisement slot opportunities across multiple content providers/publishers. The advertisers who are interested in advertising their services/product may be an individual, a company or other entity. These advertisers buy advertisement slots through advertising platforms based on a real time bidding process. These advertisers usually contacts one or more advertising agencies who design and/or implement an advertising campaign on behalf of the advertisers and procure or buy advertisement slots based on the advertising campaign either defined by the advertiser or approved the advertiser.

These advertising agencies (or sometimes advertisers themselves) bid to buy advertisement slots on the advertising exchange by doing their own analysis. At times, their analysis goes wrong and they end up bidding more than what the advertisements are supposed to generate. For example, an advertiser may deal with the advertising agency based on the number of clicks which his advertisement may receive. Now, by doing their analysis, the advertising agency selects some publishers and bids for advertisement slots. More often than not, their analysis goes wrong and they end up paying from their own pocket. In addition, owing to the nature of the auction process, the analysis of the advertiser goes wrong. For example, the publisher has many advertisement slots in a page. The advertiser cannot choose specific advertisement slots in their bids. The advertiser bids for the best possible slot and the auction mechanism allocates some other slot. In this case, because of the mismatch, the advertiser may end up with negative margin. The historical data of the mismatch between the targeted slot and the actual awarded slot should be factored in for the estimation of bid prices.

In light of the above discussion, there is a need of a method and a system which overcomes the above stated problems. In addition, the method and system should dynamically update itself in an iterative manner for reducing the errors to a minimum.

### SUMMARY OF THE INVENTION

This Summary is provided to introduce a selection of concepts in a simplified form that are further described below in the Detailed Description. This Summary is not intended to identify key or essential features of the invention, nor is it intended to be used as an aid in determining the scope of the invention.

The present invention provides a method for determining revenue margin for a bidder for an advertisement slot. The method includes receiving a candidate set of inputs associated with an advertisement impression and a specified advertisement campaign from an advertiser by an engine executing on a device through a graphical user interface. Further, the method includes computing a probable amount of money to be paid to a publisher of the advertising slot by the bidder based on the candidate set of inputs by the engine executing on the device. Furthermore, the method includes calculating a probable amount of money to be received from an advertiser by the bidder for the candidate set of inputs based on the candidate set of inputs by the engine executing on the device. In addition, the method includes determining the probable revenue margin for the advertisement slot based on inferring the outcome of the auction through a predictive model. The probable amount of money to be received from the advertiser is estimated and/or predicted based in part to a historical data for advertising slots analysed by the engine.

In an embodiment, the method further includes determining feasibility of bidding for the advertising slot for the bidder based on the determined revenue margin by the engine executing on the device. In addition, a bid is said to be feasible only if it results in a positive margin even if the targeted slot is not awarded.

In an embodiment, the method further includes incorporating an adjustment of the bid for the advertising slot based on the determined revenue margin to the bidder by the engine executing on the device through the graphical user interface. The step of incorporating the adjustment of the bid by the engine executing on the device is based on changing the probable amount of money to be paid to the publisher of the advertising slot by the bidder.

In an embodiment, the step of determining of the revenue margin by the engine executing on the device is on real time basis. In addition, the historical data for the bidder is updated dynamically for each bid for the advertisement slot of the publisher for the candidate set of inputs by the engine executing on the device.

In an embodiment, the step of receiving the candidate set of inputs by the engine executing on the device through the graphical user interface includes one or more of: a campaign goal of the advertiser, a budget of the advertiser's advertisement campaign, performance of the advertiser's advertisement campaign, and a spending pace for the budget. In an embodiment, the probable amount of money to be paid to the publisher of the advertising slot and the probable amount of money to be received from the advertiser for the advertising slot include generating a set of predicted fair value bids based on at least one of the following types of goals: cost per click (CPC), cost per lead (CPL), cost per sale (CPS), cost per action (CPA), cost per impression (CPI), return on investment (ROI), or winning a targeted portion of available advertisement impressions.

In another aspect of the present invention, a method for adjusting bid for an advertisement slot for a bidder is provided. The method includes receiving a candidate set of inputs associated with an advertisement impression and a specified advertisement campaign from an advertiser by an engine executing on a device through a graphical user interface. Further, the method includes computing a probable amount of money to be paid to a publisher of the advertising slot by the bidder based on the candidate set of inputs. Furthermore, the method includes determining the revenue margin for the advertisement slot based on the probable amount of money to be paid to the publisher and the probable amount of money to be received from an advertiser for the candidate set of inputs and suggesting for an adjustment of the bid to the bidder for the advertising slot based on the determined revenue margin. The probable amount of money to be received from the advertiser is based in part to a historical data for the advertising slot analysed by the engine and adjusted for the targeted slot position and a history of clearing prices on an advertisement exchange for the advertising slot.

In an embodiment, the step of the determining of the revenue margin for the advertisement slot by the engine executing on the device for the bidder is based on difference of the probable amount of money to be paid to the publisher and the probable amount of money to be received from an advertiser for the candidate set of inputs. In an embodiment, the step of determining of the revenue margin by the engine executing on the device is on real time basis.

In an embodiment, the historical data for the bidder is updated dynamically by the engine executing on the device for each bid for the advertisement slot of the publisher for the candidate set of inputs.

In an embodiment, the step of receiving the candidate set of inputs by the engine executing on the device through the graphical user interface includes one or more of: a campaign goal of the advertiser, a budget of the advertiser's advertisement campaign, performance of the advertiser's advertisement campaign, and a spending pace for the budget. In an embodiment, the probable amount of money to be paid to the publisher of the advertising slot and the probable amount of money to be received from the advertiser for the advertising slot include generating a set of predicted fair value bids based on at least one of the following types of goals: cost per click (CPC), cost per lead (CPL), cost per sale (CPS), cost per action (CPA), cost per impression (CPI), return on investment (ROI), or winning a targeted portion of available advertisement impressions.

In yet another aspect, a computer system for determining revenue margin for a bidder for an advertisement slot is provided. The computer system includes one or more processors and a non-transitory memory containing instructions that causes one or more processors to perform a set of steps. The set of steps includes receiving a candidate set of inputs associated with an advertisement impression and a specified advertisement campaign from an advertiser by an engine executing on the computer system through a graphical user interface. In addition, the steps include computing a probable amount of money to be paid to a publisher of the advertising slot by the bidder based on cost per impression. Further, the steps include calculating a probable amount of money to be received from an advertiser by the bidder for the candidate set of inputs based on cost per click. Furthermore, the steps include determining the revenue margin for the advertisement slot based on difference of the probable amount of money to be paid to the publisher and the probable amount of money to be received from an advertiser for the candidate set of inputs. The computation of the probable amount of money to be paid to the publisher is based in part to a historical data of cost per impression for the advertising slot.

In an embodiment, the non-transitory memory containing instructions that causes the one or more processors to perform a further step of determining feasibility of bidding for the advertising slot by the engine for the bidder by the engine executing on the device for the bidder of bidding based on the determined revenue margin.

In an embodiment, the non-transitory memory containing instructions that causes the one or more processors to perform a further step of suggesting for an adjustment of the bid for the advertising slot based on the determined revenue margin to the bidder by the engine executing on the device through a graphical user interface.

In an embodiment, the historical data for the bidder is updated dynamically by the engine executing on the computer system for each bid for the advertisement slot of the publisher for the candidate set of inputs.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates a system for enabling a bidding process in accordance with various embodiments of the present invention;

FIG. 2 illustrates various attributes of campaign goals analysed by a bidder in accordance with various embodiments of the present invention;

FIG. 3 illustrates short listing of an advertisement slot of a publisher in accordance with various embodiments of the present invention;

FIG. 4 illustrates the bidder interacting with the advertisement exchange in accordance with various embodiments of the present invention;

FIG. 5 illustrates a flow chart for determining a revenue margin for the bidder for the advertisement slot in accordance with various embodiments of the present invention;

FIG. 6 illustrates a flow chart for adjusting bid for the advertisement slot for the bidder in accordance with various embodiments of the present invention; and

FIG. 7A and FIG. 7B illustrate an operating environment as well as associated system components in which various embodiments of the present invention are practiced.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

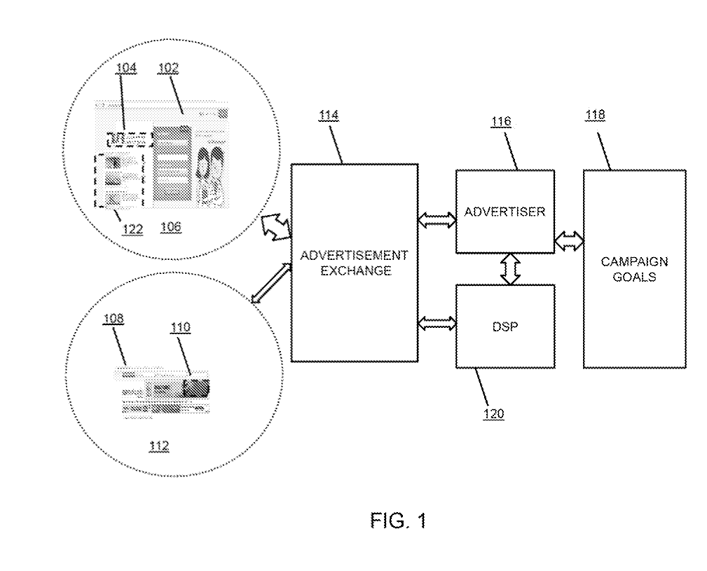

FIG. 1 illustrates a system 100 for enabling a bidding process in accordance with various embodiments of the present invention. The system 100 includes an advertisement slot 104 and an advertisement slot 122 on a web-page 102 of an online publisher 106, an advertisement slot 110 on a web-page 108 of an online publisher 112, an advertisement exchange 114, an advertiser 116, a demand side platform 120 and campaign goals 118.

The online publishers 106 and 112 provide or allocate areas or portions of their web pages 102 and 108 for advertising purposes. These areas or portions are generally differentiated from content created or published by the publishers 106 and 112. These areas or portions are referred to as the advertisement slots 104, 122 and 110. These advertisement slots 104, 122 and 110 are available for advertising products, services, or businesses not directly provided by or related to the online publishers 106 and 112. These advertisement slots 104, 122 and 110 are available to an advertiser (s) 116 for a price. It may be noted that the web-page 102 of the online publisher 106 is shown to have the advertisement slot 104 and the advertisement slot 122; however, those skilled in the art would appreciate that the web-page 102 of the online publisher 106 can have multiple advertisement slots. The price of these advertisement slots may vary depending on the location of the advertisement slot on the web-page. On the same lines, the web-page 108 can have multiple advertisement slots.

These advertisement slots 104, 122 and 110 may include any form or type of space or region on their respective web pages 102 and 108. This space or region may overlap with or reside within (or as part of) content on the page (e.g., locations for banners, ad blocks, sponsored listings, margin ads and flash displays). These advertisement slots 104, 122 and 110 are sometimes offered directly to the advertiser(s) 116. In an embodiment, the publishers 106 and 112 offer the advertisement slots 104, 122 and 110 through one or more advertisement exchange 114. The advertisement exchange 114 consolidates and/or manages the advertisement slots 104 and 110 and provides a platform for buying and selling the advertisement slots 104, 122 and 110. The advertisement exchange 114 provides services for trading the advertisement slots 104 and 110. Examples of the advertisement exchange 114 may include but may not be limited to Microsoft AdECN, Yahoo Right Media, and DoubleClick, a Google subsidiary.

In an embodiment, the advertisement exchange 114 operates as a platform, interface or mediator for matching the buyers of advertisement slots 104, 122 and 110 with a seller. It may be noted that in context of the present application, the term “buyer” refers to the advertiser 116 or an advertising agency and the term “seller” refers to the publishers 106 and 112.

The advertisement exchange 114 attempts to strike a transaction between the advertiser 116/an advertising agency and the publishers 106 and 112. Due to the benefits provided by the advertisement exchange 114, the advertisement exchange 114 commands a large share of the profit from transacting the advertisement slots 104 and 110. This may be especially true as advertisement rates or the advertisement slots 104, 122 and 110 rates drop. In another embodiment, the advertisement exchange 114 brokering a transaction between the seller (the publishers 106 and 112) and multiple buyers (the advertiser 116/the advertising agency) provide more value to the sellers than to the buyers.

In another embodiment, the advertisement exchange 114 represents only a limited pool of the advertisement slots 104, 122 and 110 to the buyer. Furthermore, the advertisement exchange 114 may offer less competitive terms to the buyer for the given advertisement slots 104, 122 and 110 as compared to another advertising exchange.

In an embodiment, the transaction interface provided by the advertisement exchange 114 to the buyer includes unique and/or proprietary processes, specific configuration of impression opportunity-related information, non-standard transaction terms and/or parameters. Due to the non-standard transaction interface provided by each advertising exchange, the seller may not be able to determine a preferred advertising exchange(s) to work with.

In an embodiment, the systems and methods disclosed herein provide a single interface for the buyer to access a plurality of advertising exchanges, and integrate multiple pools of advertisement slots from these advertising exchanges for bidding by the buyer. This single interface is referred to as a demand side platform 120 (hereinafter the DSP “120”). In an embodiment, the DSP 120 integrates and interfaces to multiple exchanges to provide normalized access to a cross-exchange spectrum of disparate and different supply source. In addition, the DSP 120 integrates and interfaces to third party advertisement servers for reporting on performance and/or operations. Further, the DSP 120 calculates daily impression estimates for the multiple exchanges and campaigns. Furthermore, the DSP 120 provides an interface to match buyer demand to supplier supply by matching against the inventory of advertisement slots. Moreover, the DSP 120 provides a system to trade demand to supply to connect a plurality of buyers (demand) across a plurality of disparate sellers.

In an embodiment, each advertising agency represents the one or more advertiser (s) 116 (clients of advertising agencies). Client entities interested in the advertisement slots 104 and 110 may comprise an individual, company, organization or groups of individual with shared interests.

In an embodiment, the advertising agency may design and/or implement an ad campaign on behalf of the advertiser 116 based on the advertisement campaign goals 118. The advertiser 116 may further procure or buy the advertisement slots 104 and 110 based on the advertising campaign on behalf of the advertiser 116.

It may be noted that in context of the present application, the advertising agency and/or one or more clients of the agency can be collectively or individually be referred to as the advertiser 116. In an embodiment, the advertiser 116 includes an advertising agency and a client the agency represents. A client may be an advertiser that directly uses the DSP 120 to procure the advertisement slots 104 and 110, e.g., without using an ad agency. In an embodiment, the advertising agency uses the DSP 120 to concurrently and/or independently run advertising campaigns for one or more clients. In another embodiment, the advertisement exchange 114 may interface with the advertiser 116 via the DSP 120. In yet another embodiment, the advertisement exchange 114 interface directly with the advertiser 116 that uses the DSP 120 to process information provided by the advertisement exchange 114.

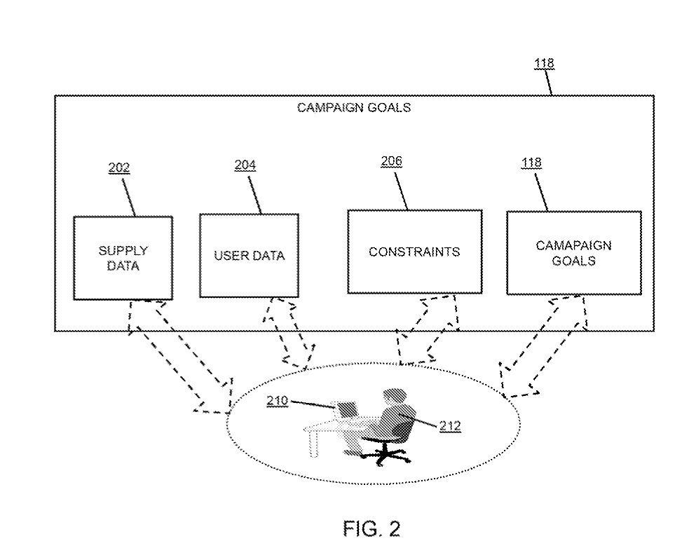

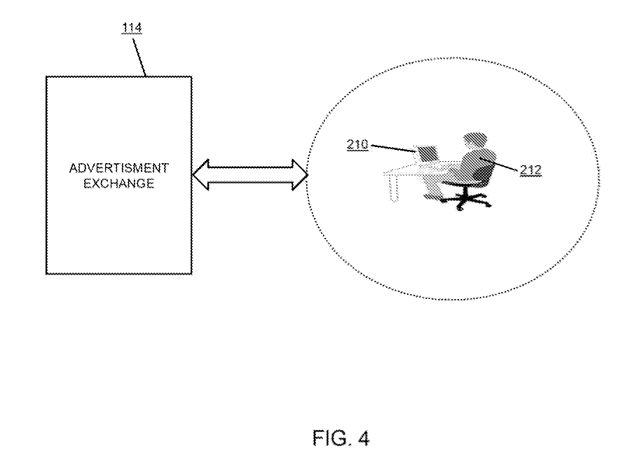

In an embodiment, as shown in FIG. 2, a bidder 212 understands and analyses the campaign goals 118 in conjunction with a supply data 202, a user data 204 and constraints 206. In an embodiment, the bidder 212 interacts with the DSP 120 to bid for the advertising slots 104 and 110. In another embodiment, as shown in FIG. 4, the bidder 212 interacts with the advertisement exchange 114 to bid for the advertising slots 104 and 110.

The user data 204 includes any type or form of data related to a user of a webpage, website, web session and/or web application. Such user information may include geolocation or geographical (sometimes generally referred to as “geo”) information, system data, remarketing information, and third-party segment information. Geo information may include information including but not limited to information related to the user network, internet protocol (IP) address, access point (e.g., wifi hotspot), geographical location and mobile tracking, and demographic and other geographical information system (GIS) data linked to the user location. System data may include any user information stored or tracked by the publishers 106 or 112, including but not limited to user preferences, browsing and transaction history, and user device information. Some of the information may be tracked by cookies and/or Adware. Third-party segment information includes information identifying specific audience segments with certain online shopping habits. In addition to the above, the user data 204 may include “IXI” data that provides measures of user wealth, income, spending, credit, investment style, share-of-wallet and share-of-market.

The supply data 202 includes any type or form of data related to the advertisement slots 104, 110, or 122. The supply data 202 may include information related to, but not limited to the network, publisher, channel, ad size, potential number of slots (in case of advertisement slot 122), and day part. Network data may include information including but not limited to information related to the size, characteristics and audience reach of an ad network associated with an impression opportunity. Publisher data may include information including but not limited to information related to the content and web traffic of a publisher or website offering an impression opportunity. Publisher data may include an identifier of the publisher and/or website. Daypart information specifies portions of the days during which the advertisement slots 104 and 110 are offered, e.g., 12:00 pm-6:00 pm, 6:00 pm-9:00 pm, primetime, morning segment, late night, etc. Weekpart information specify between weekend and weekday. The channel data may include information including but not limited to information related to the type and reach of a media channel associated with an impression opportunity. Examples of the constraints 206 of the advertiser 116 can be the location of the target audience (say USA, Europe, and India). In addition, examples of the goals 118 of the advertiser 116 can be budget expenditure for a particular advertisement campaign.

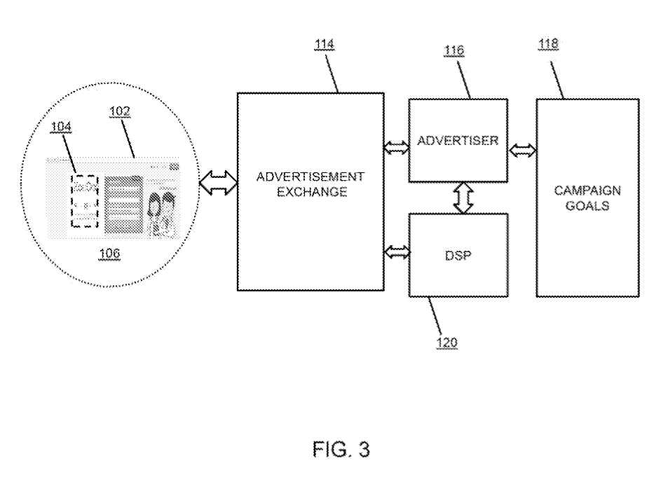

In an embodiment, the bidder 212 acts on the behalf of the advertiser 116. In another embodiment, the bidder 212 acts on the behalf of the advertising agency. The bidder 212 analyses the supply data 202, the user data 204, the constraints 206 and the goals 118. The bidder 212 may shortlist one of the advertisement slot from the advertisement slots 104 and 110 based on the analysis. As shown in FIG. 3, the bidder 212 chooses the advertisement slot 104 of the web-page 102 of the publisher 106. It may be noted that the bidder 212 is shown to choose the advertisement slot 104 of the web-page 102 of the publisher 106, however, those skilled in the art would appreciate that the bidder 212 can choose one or more of the advertisement slots based on the analysis of one or more of the supply data 202, the user data 204, the constraints 206 and the goals 118.

The bidder 212 uses a computing device 210 to interact with the advertisement exchange 114 or the DSP 120 to bid for the advertisement slot 104. The computing device 210 provides the candidate set of inputs through a graphical user interface such as the supply data 202, the user data 204, the constraints 206 and the goals 118 to the bidder 212 for analysis.

In an embodiment, the bidder 212 charges for posting an advertisement impression of the advertiser 116 based on the cost per click (hereinafter ‘CPC’) on the advertisement slot 104. The bidder bids for the advertisement slot 104 of the publisher 106 based on cost per impression (hereinafter CPI). An engine of the computing device 210 calculates the revenue margin for the bidder 212 based on the analysis of the previous bids made by the bidder 212 for the advertisement slot 104 and a probability of conversion of advertisement impression on the advertisement slot 104 on the web-page 102. In an embodiment, the engine of the computing device 210 automatically calculates the probability of conversion of the impression into clicks based on the analysis of the history of the advertisement slot 104, the previous bids made by the bidder 212 in conjunction with the candidate set of inputs like the supply data 202, the user data 204, the constraints 206 and the goals 118. In an embodiment, the engine of the computing device 210 determines the revenue margin based on difference of the probable amount of money to be paid to the publisher 106 and the probable amount of money to be received from the advertiser 116. In case of advertisement slots like 122, the advertiser 116 calculates the probable revenue for the best slot (e.g., top slot). In the bidding process, they may end up winning any other slot.

In an embodiment, the engine of the computing device 210 provides the probable revenue margin to the bidder 212 through the graphical user interface. In an embodiment, if the engine determines that the probable revenue margin is lower than expected by the bidder 212 or if the probable revenue margin is negative, then the bidder 212 adjust the bids for making the probable revenue margin on a higher side. In another embodiment, the engine of the computing device 210 determines the feasibility of bidding for the advertising slot 104 for the bidder 212 based on the determined revenue margin. If the probable determined revenue margin is negative for the candidate set of inputs for the advertisement slot 104, the engine of the computing device 210 may suggest an adjustment of the bid or may suggest that it is not advisable to bid for the advertisement slot 104.

In an embodiment of the present invention, the engine of the computing device 210 updates its database in real time when the bidder 212 bids on the advertisement slot 104. Next time, when the bidder 212 bids for the advertisement slot 104 with the candidate set of inputs, the engine of the computing device 210 will calculate the probable revenue margin based on amount of the last bid, the outcome of the last bid and other historical data. The outcome of the bid includes but may not be limited to the conversion of impressions into clicks for the advertisement slot 104 and performance of the conversion of advertisement impressions. In another embodiment, the probable amount of money to be received from the advertiser 116 is based in part to a historical data for the advertising slot 104 analysed by the engine and a history of clearing prices on the advertisement exchange 114 for the advertising slot 104.

It may be noted that in context of the present application, the probable amount of money received from the advertiser 116 is calculated by considering cost-per-click criteria. However, those skilled in the art would appreciate that the probable amount of money received from the advertiser 116 can be based on criteria which include but may not be limited to cost per lead (CPL), cost per sale (CPS), cost per action (CPA), cost per impression (CPI), return on investment (ROI), and winning a targeted portion of available advertisement impressions. On the similar lines, in context of the present application, the probable amount of money to be paid to the publisher 106 for the advertising slot 104 is calculated by considering cost-per-impression. However, those skilled in the art would appreciate that probable amount of money to be paid to the publisher 106 for the advertising slot 104 can be calculated based on at least one of the following types of goals: cost per click (CPC), cost per lead (CPL), cost per sale (CPS), cost per impression (CPI), cost per action (CPA), return on investment (ROI) and/or winning a targeted portion of available advertisement impressions. In the above stated embodiment, the probable revenue margin is calculated based on the difference of the probable amount of money to be received from the advertiser 116 and the probable amount of money to be paid to the publisher 106 for the advertising slot 104 or any other mathematical/statistical calculations presently known in the art.

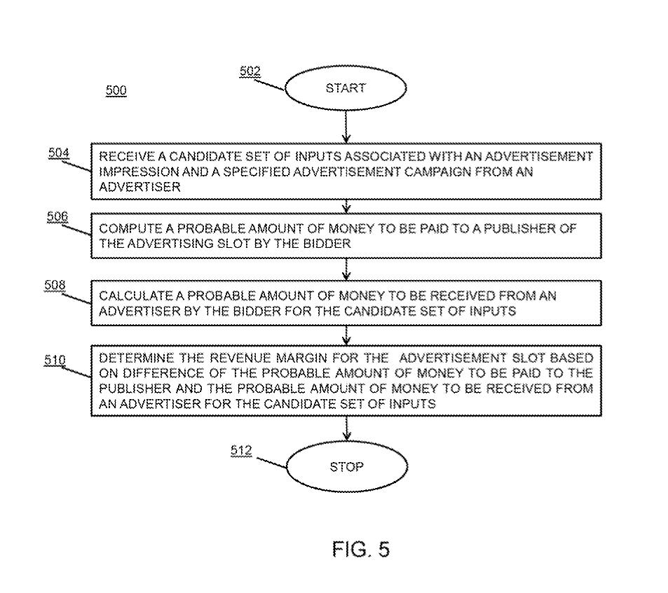

FIG. 5 illustrates a flow chart 500 for determining a revenue margin for the bidder 212 for the advertisement slot 104 in accordance with various embodiments of the present invention. It may be noted that to explain the flow chart 500, reference will be made to the elements of FIG. 1, FIG. 2, FIG. 3 and FIG. 4.

The flow chart 500 initiates at step 502. At step 504, the engine of the computing device 210 receives the candidate set of inputs associated with an advertisement impression and the specified advertisement campaign from the advertiser 116. The candidate set of inputs include but may not be limited to the supply data 202, the user data 204, the constraints 206 and the campaign goals 116. At step 506, the engine executing on the computing device 210 computes a probable amount of money to be paid to the publisher 106 of the advertising slot 104 by the bidder 212. At step 508, the engine executing on the computing device 210 computes a probable amount of money to be received from the advertiser 116 by the bidder 212 for the candidate set of inputs. The probable amount of money to be received from the advertiser 116 is based in part to a historical data for the advertising slot 104 analysed by the engine of the computing device 210. At step 510, the engine executing on the computing device 210 determines the revenue margin for the advertisement slot 104 based on the difference of the probable amount of money to be paid to the publisher 106 and the probable amount of money to be received from the advertiser 116 for the candidate set of inputs. The flow chart terminates at step 512.

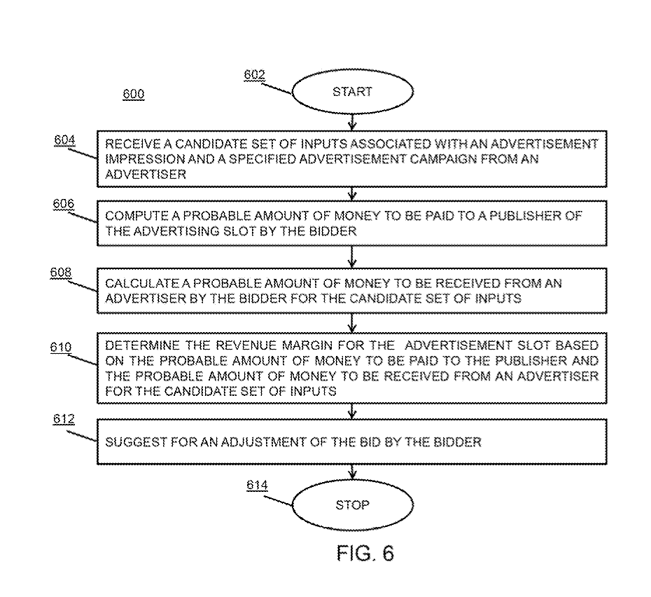

FIG. 6 illustrates a flow chart 600 for adjusting a bid for the advertisement slot 104 for the bidder 212 in accordance with various embodiments of the present invention. It may be noted that to explain the flow chart 600, reference will be made to the elements of FIG. 1, FIG. 2, FIG. 3, FIG. 4 and FIG. 5.

The flow chart 600 initiates at step 602. At step 604, the engine of the computing device 210 receives the candidate set of inputs associated with an advertisement impression and the specified advertisement campaign from the advertiser 116. At step 606, the engine executing on the computing device 210 computes a probable amount of money to be paid to the publisher 106 of the advertising slot 104 by the bidder 212. At step 608, the engine executing on the computing device 210 computes a probable amount of money to be received from the advertiser 116 by the bidder 212 for the candidate set of inputs. The probable amount of money to be received from the advertiser 116 is based in part to a historical data for the advertising slot 104 analysed by the engine of the computing device 210 and a history of clearing prices on the advertisement exchange 114 for the advertising slot 104. At step 610, the engine executing on the computing device 210 determines the revenue margin for the advertisement slot 104 based on the probable amount of money to be paid to the publisher 106 and the probable amount of money to be received from the advertiser 116 for the candidate set of inputs. At step 612, the engine executing on the computing device 210 suggests for an adjustment of the bid based on the determined revenue margin to the bidder 212 through the graphical user interface. The flow chart terminates at step 614.

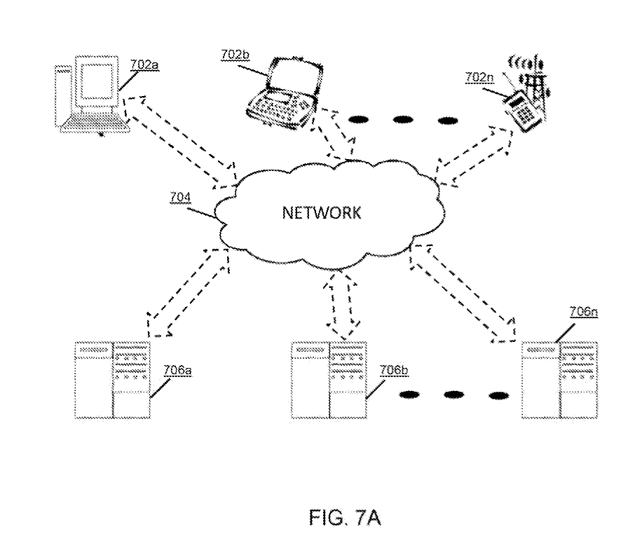

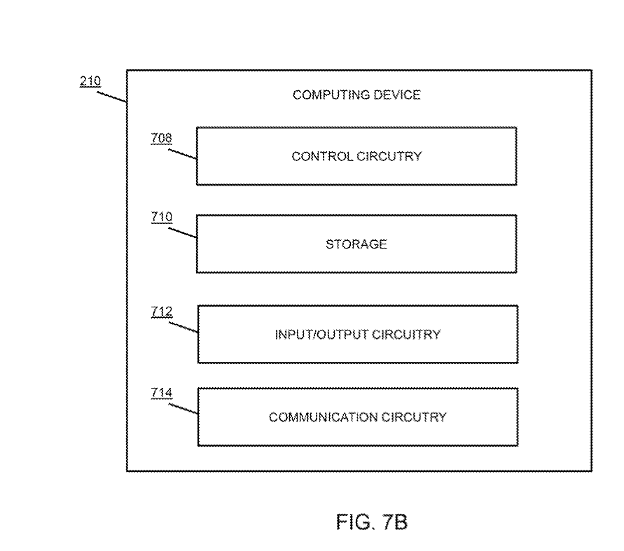

FIG. 7A and FIG. 7B illustrate an operating environment as well as associated system components in which various embodiments of the present invention are practiced. As shown in FIG. 7A, the network environment includes one or more clients 702a-702n. These one or more clients 702a-702n are generally referred to as local machine(s) 702, client(s) 702, client node(s) 702, client machine(s) 702, client computer(s) 702, client device(s) 702, endpoint(s) 702, or endpoint node(s) 702). These clients 702a-702n communicates with one or more servers 706a-706n via one or more networks 704. These servers 706a-706n are generally referred to as a server(s) 706, a node 706, or a remote machine(s) 706.

In an embodiment, a client 702 function as both a client node seeking access to resources provided by a server and as a server providing access to hosted resources for other clients 702a-702n. Although FIG. 7A shows the network 704 between the clients 702 and the servers 706, however, those skilled in the art would appreciate that the clients 702 and the servers 706 may be on the same network 704. In addition, examples of the network 704 include but may not be limited to a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wire line network.

In an embodiment, the network 704 may include a wireless link, such as an infrared channel or satellite band. In addition, the topology of the network 704 may be a bus, star, ring network topology or any such network topology that is capable of supporting the methods and systems of the present invention.

The network 704 may comprise mobile telephone networks utilizing any protocol or protocols used to communicate among mobile devices, including AMPS, TDMA, CDMA, GSM, GPRS or UMTS. Those skilled in the art would appreciate that there can be the multiple networks 704 between the clients 702 and the servers 706. In one of the embodiment, the network 704′ may be the private network and a network 704 may be a public network. In another embodiment, the network 704 may be a private network and the network 704′ may be a public network. In still another embodiment, the networks 704 and 704′ may both be private networks.

In an embodiment, different types of data may be transmitted via different protocols. In another embodiment, the same types of data may be transmitted via different protocols. In addition, in an embodiment, the system may include multiple, logically—the grouped servers 706. The logical group of servers may be referred to as a server farm or a machine farm. In another embodiment, the servers 706 may be geographically dispersed. In yet another embodiment, a machine farm may be administered as a single entity. In yet another embodiment, the machine farm includes a plurality of machine farms. The servers 706 within each machine farm can be heterogeneous—one or more of the servers 706 or machines 702 can operate according to one type of operating system platform (e.g., WINDOWS NT, manufactured by Microsoft Corp. of Redmond, Wash.), while one or more of the other servers 706 can operate on according to another type of operating system platform (e.g., Unix or Linux).

In an embodiment, the server 706 may be a file server, an application server, a web server, a proxy server, an appliance, a network appliance, a gateway, a gateway server, a virtualization server, deployment server, a SSL VPN server, or a firewall. In one embodiment, the server 706 may be referred to as a remote machine or a node. In another embodiment, a plurality of nodes 290 may be in the path between any two communicating servers.

In an embodiment, the server 706 provides the functionality of a web server. In another embodiment, the server 706a receives requests from the client 702, forwards the requests to a second server 706b and responds to the request by the client 702 with a response to the request from the server 706b. In yet another embodiment, the server 706 presents the response to the request to the client 702 using a web interface. In an embodiment, the client 702 communicates directly with the server 706 to access the identified application. In another embodiment, the client 702 receives output data, such as display data, generated by an execution of the identified application on the server 706.

It may be noted that the client 702 and the server 706 may be deployed as and/or executed on any type and form of computing device, such as a computer, network device or appliance capable of communicating on any type and form of network and performing the operations described herein.

FIG. 7B depicts block diagrams of the computing device 210 for practicing an embodiment of the client 702 and/or the server 706. As shown in FIG. 7B, the computing device 210 includes a control circuitry 708, storage 710, an input/output (“I/O”) circuitry 712 and a communications circuitry 714.

Those skilled in the art would appreciate that the computing device 210 of FIG. 7B may include one or more components which may not be shown here. These one or more components of the computing device 210 may be combined or omitted with the components shown in FIG. 7B. The computing device 210 includes any suitable type of electronic device. Examples of the computing device 210 include but may not be limited to a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a Smartphone, a handheld gaming device, a digital camera, a laptop computer, and a tablet computer. In another embodiment of the present invention, the computing device 210 can be a desktop computer.

From the perspective of this invention, the control circuitry 708 includes any processing circuitry or processor operative to control the operations and performance of the computing device 210. For example, the control circuitry 708 may be used to run operating system applications, firmware applications, media playback applications, media editing applications, or any other application. In an embodiment, the control circuitry 708 drives a display and process inputs received from a user interface.

From the perspective of this invention, the storage 710 includes one or more storage mediums including a hard-drive, solid state drive, flash memory, permanent memory such as ROM, any other suitable type of storage component, or any combination thereof. The Storage 710 may store, for example, media data (e.g., music and video files), application data (e.g., for implementing functions on the computing device 210).

From the perspective of this invention, the I/O circuitry 712 may be operative to convert (and encode/decode, if necessary) analog signals and other signals into digital data. In an embodiment, the I/O circuitry 712 may also convert digital data into any other type of signal, and vice-versa. For example, the I/O circuitry 712 may receive and convert physical contact inputs (e.g., from a multi-touch screen), physical movements (e.g., from a mouse or sensor), analog audio signals (e.g., from a microphone), or any other input. The digital data may be provided to and received from the control circuitry 708, the storage 710, or any other component of the computing device 210.

It may be noted that the I/O circuitry 712 is illustrated in FIG. 7B as a single component of the computing device 210; however those skilled in the art would appreciate that several instances of the I/O circuitry 712 may be included in the computing device 210.

The computing device 210 may include any suitable interface or component for allowing a user to provide inputs to the I/O circuitry 712. The computing device 210 may include any suitable input mechanism. Examples of the input mechanism include but may not be limited to a button, keypad, dial, a click wheel, and a touch screen. In an embodiment, the computing device 210 may include a capacitive sensing mechanism, or a multi-touch capacitive sensing mechanism.

In an embodiment, the computing device 210 may include specialized output circuitry associated with output devices such as, for example, one or more audio outputs. The audio output may include one or more speakers built into the computing device 210, or an audio component that may be remotely coupled to the computing device 210.

The one or more speakers can be mono speakers, stereo speakers, or a combination of both. The audio component can be a headset, headphones or ear buds that may be coupled to communications device with a wire or wirelessly.

In an embodiment, the I/O circuitry 712 may include display circuitry for providing a display visible to the user. For example, the display circuitry may include a screen (e.g., an LCD screen) that is incorporated in the computing device 210.

The display circuitry may include a movable display or a projecting system for providing a display of content on a surface remote from the computing device 210 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 708. Alternatively, the display circuitry may be operative to provide instructions to a remote display.

From the prospective of this invention, a communications circuitry 714 may include any suitable communications circuitry operative to connect to a communications network and to transmit communications (e.g., voice or data) from the computing device 210 to other devices within the communications network. The communications circuitry 714 may be operative to interface with the communications network using any suitable communications protocol. Examples of the communications protocol include but may not be limited to Wi-Fi, Bluetooth®, radio frequency systems, infrared, LTE, GSM, GSM plus EDGE, CDMA, and quadband.

In an embodiment, the communications circuitry 714 may be operative to create a communications network using any suitable communications protocol. For example, the communications circuitry 714 may create a short-range communications network using a short-range communications protocol to connect to other devices. For example, the communications circuitry 714 may be operative to create a local communications network using the Bluetooth® protocol to couple the computing device 210 with a Bluetooth® headset.

It may be noted that the computing device is shown to have only one communication operation; however, those skilled in the art would appreciate that the computing device 210 may include one more instances of the communications circuitry 714 for simultaneously performing several communications operations using different communications networks. For example, the computing device 210 may include a first instance of the communications circuitry 714 for communicating over a cellular network, and a second instance of the communications circuitry 714 for communicating over Wi-Fi or using Bluetooth®.

In an embodiment, the same instance of the communications circuitry 714 may be operative to provide for communications over several communications networks. In an embodiment, the computing device 210 may be coupled a host device for data transfers, synching the communications device, software or firmware updates, providing performance information to a remote source (e.g., providing riding characteristics to a remote server) or performing any other suitable operation that may require the computing device 210 to be coupled to a host device. Several computing devices may be coupled to a single host device using the host device as a server. Alternatively or additionally, the computing device 210 may be coupled to several host devices (e.g., for each of the plurality of the host devices to serve as a backup for data stored in the computing device 210).

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

Common forms of non-transitory computer-readable storage medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer may read.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method for maximizing the revenue margin for a bidder for a set of advertisement slots, the method comprising:
receiving, by an engine executing on a device through a graphical user interface, a candidate set of inputs associated with an advertisement impression and a specified advertisement campaign from an advertiser;
computing, by said engine executing on said device based on said candidate set of inputs, a probable amount of money to be paid to a publisher of the said set of advertising slots by said bidder;
calculating, by said engine executing on said device based on said candidate set of inputs, a probable amount of money to be received from an advertiser by said bidder for said candidate set of inputs, wherein said probable amount of money to be received from said advertiser is based in part to a historical data for said advertising slot analysed by said engine; and
determining, by said engine executing on said device for said bidder, said revenue margin for said advertisement slot based on difference of said probable amount of money to be paid to said publisher and said probable amount of money to be received from an advertiser for said candidate set of inputs.

2. The method as recited in claim 1, further comprising determining a feasibility of positive margin for said advertising slots by said engine for said bidder by said engine executing on said device for said bidder of bidding based on said determined revenue margin.

3. The method as recited in claim 1, further comprising suggesting for an adjustment of said bid by said bidder by said engine executing on said device through said graphical user interface for said advertising slot based on said determined revenue margin.

4. The method as recited in claim 3, wherein said step of suggesting said adjustment is based on changing said probable amount of money to be paid to a publisher of said advertising slot by said bidder.

5. The method as recited in claim 1, wherein said step of determining of said revenue margin by said engine executing on said device is on real time basis.

6. The method as recited in claim 1, wherein said historical data for said bidder is updated dynamically by said engine executing on said device for each bid for said advertisement slot of said publisher for said candidate set of inputs.

7. The method as recited claim 1, wherein said step of receiving said candidate set of inputs by said engine executing on said device through said graphical user interface comprising one or more of: a campaign goal of said advertiser, a budget of the advertiser's advertisement campaign, performance of the advertiser's advertisement campaign, and a spending pace for the budget.

8. The method of claim 1, wherein said probable amount of money to be paid to said publisher of said advertising slot further comprises generating a set of predicted fair value bids based on at least one of the following types of goals: cost per click (CPC), cost per lead (CPL), cost per sale (CPS), cost per action (CPA), cost per impression (CPI), return on investment (ROI), or winning a targeted portion of available advertisement impressions.

9. The method of claim 8, wherein the said predicted fair value is calculated based on adjusting the historical data for the target advertisement slot.

10. The method of claim 1, wherein said probable amount of money to be received from said advertiser for said advertising slot further comprises generating a set of predicted fair value bids based on at least one of the following types of goals: cost per click (CPC), cost per lead (CPL), cost per sale (CPS), cost per impression (CPI), cost per action (CPA), return on investment (ROI), or winning a targeted portion of available advertisement impressions.

11. A method for adjusting bid for an advertisement slot for a bidder, the method comprising:
receiving, by an engine executing on a device through a graphical user interface, a candidate set of inputs associated with an advertisement impression and a specified advertisement campaign from an advertiser;
computing, by said engine executing on said device based on said candidate set of inputs, a probable amount of money to be paid to a publisher of said advertising slot by said bidder; and
calculating, by said engine executing on said device based on said candidate set of inputs, a probable amount of money to be received from an advertiser by said bidder for said candidate set of inputs, wherein said probable amount of money to be received from said advertiser is based in part to a historical data for said advertising slot analysed by said engine and a history of clearing prices on an advertisement exchange for said advertising slot;
determining, by said engine executing on said device for said bidder, said revenue margin for said advertisement slot based on said probable amount of money to be paid to said publisher and said probable amount of money to be received from an advertiser for said candidate set of inputs; and
suggesting for an adjustment of said bid for said advertising slot based on said determined revenue margin to said bidder by said engine executing on said device through a graphical user interface.

12. The method as recited in claim 11, wherein step of said determining of said revenue margin for said advertisement slot by said engine executing on said device for said bidder is based on difference of said probable amount of money to be paid to said publisher and said probable amount of money to be received from an advertiser for said candidate set of inputs.

13. The method as recited in claim 11, wherein said step of determining of said revenue margin by said engine executing on said device is on real time basis.

14. The method as recited in claim 11, wherein said historical data for said bidder is updated dynamically by said engine executing on said device for each bid for said advertisement slot of said publisher for said candidate set of inputs.

15. The method as recited claim 11, wherein said step of receiving said candidate set of inputs by said engine executing on said device through said graphical user interface comprising one or more of: a campaign goal of said advertiser, a budget of the advertiser's advertisement campaign, performance of the advertiser's advertisement campaign, and a spending pace for the budget.

16. The method as recited in claim 11, wherein said probable amount of money to be paid to said publisher of said advertising slot further comprises generating a set of predicted fair value bids based on at least one of the following types of goals: cost per click (CPC), cost per lead (CPL), cost per sale (CPS), cost per action (CPA), return on investment (ROI), or winning a targeted portion of available advertisement impressions.

17. The method as recited in claim 11, wherein said probable amount of money to be received from said advertiser for said advertising slot further comprises generating a set of predicted fair value bids based on at least one of the following types of goals: cost per click (CPC), cost per lead (CPL), cost per sale (CPS), cost per action (CPA), cost per impression (CPI), return on investment (ROI), or winning a targeted portion of available advertisement impressions.

18. A computer system for determining revenue margin for a bidder for an advertisement slot, the system comprising:
one or more processors; and
a non-transitory memory containing instructions that, when executed by said one or more processors, causes said one or more processors to perform a set of steps comprising:
receiving, by an engine executing on said computer system through a graphical user interface, a candidate set of inputs associated with an advertisement impression and a specified advertisement campaign from an advertiser;
computing, by said engine executing on said device based on said candidate set of inputs, a probable amount of money to be paid to a publisher of said advertising slot by said bidder based on cost per impression, wherein computing said probable amount of money to be paid to said publisher is based in part to a historical data of cost per impression for said advertising slot;
calculating, by said engine executing on said device based on said candidate set of inputs, a probable amount of money to be received from an advertiser by said bidder for said candidate set of inputs based on cost per click; and
determining, by said engine executing on said device for said bidder, said revenue margin for said advertisement slot based on difference of said probable amount of money to be paid to said publisher and said probable amount of money to be received from an advertiser for said candidate set of inputs.

19. The computer system as recited in claim 18, wherein said non-transitory memory containing instructions that, when executed by said one or more processors, cause said one or more processors to perform a further step of determining a feasibility of bidding for said advertising slot by said engine for said bidder by said engine executing on said device for said bidder of bidding based on said determined revenue margin.

20. The computer system as recited in claim 18, wherein said non-transitory memory containing instructions that, when executed by said one or more processors, cause said one or more processors to perform a further step of suggesting for an adjustment of said bid for said advertising slot based on said determined revenue margin to said bidder by said engine executing on said device through a graphical user interface.
